(19) United States
(12) Patent Application Publication
(10) Pub. No.: US 2010/0069082 A1
(43) Pub. Date: Mar. 18, 2010

(54) METHOD FOR CONFIGURATING A FEEDBACK REGION IN WIRELESS COMMUNICATION SYSTEM

(75) Inventors: Ki-Seok Kim, Kyungsangbuk-do (KR); Hyun-Jae Kim, Incheon-city (KR); Seok-Jin Lee, Daejeon-city (KR); Young-Il Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute of Daejeon-city, Daejeon-city (KR)

(21) Appl. No.: 12/513,073

(22) PCT Filed: Oct. 31, 2007
(86) PCT No.: PCT/KR07/05474

§ 371 Date: Apr. 30, 2009

(30) Foreign Application Priority Data
Oct. 31, 2006 (KR) 10-2006-0106629
Oct. 30, 2007 (KR) 10-2007-0109610

(51) Int. Cl. H04W 72/08; H04B 17/00

(52) U.S. Cl. 455/452.2; 455/67.13

(57) ABSTRACT

Provided is a method of configuring a feedback zone in an uplink zone of a frame. This method is for transmitting feedback data in a wireless communication system. The method sets the feedback zone between a relay station (RS) and a mobile station (MS) in addition to a feedback zone between the MS and a base station (BS), thereby preventing a transmission delay of the feedback data incurred by the RS.

### TECHNICAL FIELD

The present invention relates to a wireless communication system, and more particularly, to a method of configuring a feedback zone for transmitting feedback data in a wireless communication system and a system thereof.

The present invention is derived from research which was supported by the ‘Information Technology (IT) Research and Development Program’ of the Ministry of Information and Communications (MIC)/the Institute for Information Technology Advancement (IITA), Republic of Korea. The project management No. is ‘2006-S-011-01, and the title is ‘Development of relay/mesh communication system for multi-hop WiBro’

### BACKGROUND ART

FIG. 1 is a diagram illustrating a configuration of a conventional Mobile Multi-hop Relay (MMR) system.

Referring to FIG. 1, a Relay Station (RS) 110 receives a signal from a Base Station (BS) 100 and transmits the signal to a zone 140 which is difficult for the signal from the BS to reach. Also, the RS 110 receives signals that have difficulty in reaching the BS 100, from Mobile Stations (MSs) 120 and 122 in the zone 140 of the RS 110, and transfers the signals to the BS 100. In this manner, the MMR system using the RS 110 has been introduced to expand cell coverage or increase service performance in a Worldwide Interoperability for Microwave Access (WiMAX) system or the like.

An uplink of a general Orthogonal Frequency Division Multiplexing (OFDM) system includes an ACK channel for transmitting ACK/NACK data, a feedback channel for transmitting channel quality information, and a control channel such as a ranging channel for transmitting an initial ranging signal and a periodic ranging signal. The WiMAX system transmits feedback data by using the feedback channel as a unique control channel, thereby enabling an MS to rapidly respond to channel quality requirement of a BS.

However, in a conventional OFDM/Time Division Duplexing (TDD) system, a separate feedback channel does not exist between a RS and the BS, and thus, a considerable delay occurs when the RS re-transmits the feedback data, which is received from the MS, to the BS. That is, the RS transforms the feedback data received from the MS into a message form and thereby transmits the transformed message to the BS via a data channel or via the feedback channel in an uplink zone of a next frame.

When the RS generates a new message for the feedback data and transmits the generated new message via a data channel of an allocated RS-BS zone, the BS interprets the generated new message and recognizes the feedback data, whereby a considerable time delay occurs. A method of transmitting the feedback data via a feedback channel of a RS-BS zone of a next frame also has a problem since the method causes a delay of up to one frame.

### DESCRIPTION OF THE DRAWINGS

FIG. 1 is a diagram illustrating a configuration of a conventional Mobile Multi-hop Relay (MMR) system,

FIG. 2 is a diagram illustrating an example of a structure of a frame of a Worldwide Interoperability for Microwave Access (WiMAX) Time Division Duplexing (TDD) system,

FIG. 3 is a flowchart of a method of transmitting feedback data in the WiMAX TDD system according to an embodiment of the present invention,

FIG. 4 is a diagram illustrating an example of a framestructure in an MMR system,

FIG. 5 is a diagram illustrating an example of a method of transmitting the feedback data by a RS in the MMR system,

FIG. 6 is a diagram illustrating a framestructure in an MMR system, according to an embodiment of the present invention,

FIG. 7 is a flowchart illustrating a method of configuring a feedback zone of the framestructure illustrated in FIG. 6 in the MMR system according to another embodiment of the present invention,

FIG. 8 is a diagram illustrating a framestructure in an MMR system, according to another embodiment of the present invention,

FIG. 9 is a flowchart illustrating a method of configuring a feedback zone of the framestructure illustrated in FIG. 8 in the MMR system according to another embodiment of the present invention,

FIG. 10 is a diagram illustrating a framestructure in an MMR system, according to another embodiment of the present invention, and

FIG. 11 is a flowchart illustrating a method of configuring a feedback zone of the framestructure illustrated in FIG. 10 in the MMR system according to another embodiment of the present invention.

### DETAILED DESCRIPTION OF THE INVENTION

### Technical Problem

The present invention provides a method of configuring a feedback zone which can transmit feedback data such as channel quality information in one frame without a delay in a Relay Station (RS).

The present invention also provides a recording medium having recorded thereon a framestructure including a feedback zone which can transmit feedback data in one frame without a delay in a RS.

### Technical Solution

According to an aspect of the present invention, there is provided a method of configuring a feedback zone in a base station (BS), the method including the operations of allocating a first feedback zone in an access zone in which data is transmitted from a mobile station (MS) to the BS; and allocating a second feedback zone in a relay zone in which data is transmitted from a relay station (RS) to the BS, wherein the second feedback zone corresponds to the first feedback zone.

According to another aspect of the present invention, there is provided a method of configuring a feedback zone in a RS, the method including the operations of receiving allocation information, of a first feedback zone allocated to an access zone in which data is transmitted from an MS to a BS, from the BS; and allocating a second feedback zone to an relay zone in which data is transmitted from the RS to the BS based on the allocation information of the first feedback zone, wherein the second feedback zone corresponds to the first feedback zone.

According to another aspect of the present invention, there is provided a recording medium having recorded thereon a framestructure, the framestructure including a first feedback zone allocated to an access zone in which data is transmitted from an MS to a RS or a BS; and a second feedback zone allocated to a zone in which data is transmitted from the RS to the BS, wherein the second feedback zone corresponds to the first feedback zone.

### Advantageous Effects

According to the present invention, a Relay Station (RS) transmits feedback data, which is received from a Mobile Station (MS), to a Base Station (BS) in one frame without a delay, thereby preventing a transmission delay.

### Best Mode

According to an aspect of the present invention, there is provided a method of configuring a feedback zone in a base station (BS), the method including the operations of allocating a first feedback zone in an access zone in which data is transmitted from a mobile station (MS) to the BS; and allocating a second feedback zone in a relay zone in which data is transmitted from a relay station (RS) to the BS, wherein the second feedback zone corresponds to the first feedback zone.

According to another aspect of the present invention, there is provided a method of configuring a feedback zone in a RS, the method including the operations of receiving allocation information, of a first feedback zone allocated to an access zone in which data is transmitted from an MS to a BS, from the BS; and allocating a second feedback zone to an relay zone in which data is transmitted from the RS to the BS based on the allocation information of the first feedback zone, wherein the second feedback zone corresponds to the first feedback zone.

According to another aspect of the present invention, there is provided a recording medium having recorded thereon a framestructure, the framestructure including a first feedback zone allocated to an access zone in which data is transmitted from an MS to a RS or a BS; and a second feedback zone allocated to a zone in which data is transmitted from the RS to the BS, wherein the second feedback zone corresponds to the first feedback zone.

### Mode for Invention

Hereinafter, a method of configuring a feedback zone in a wireless communication system and a system thereof according to the present invention will now be described more fully with reference to the accompanying drawings, in which exemplary embodiments of the invention are shown.

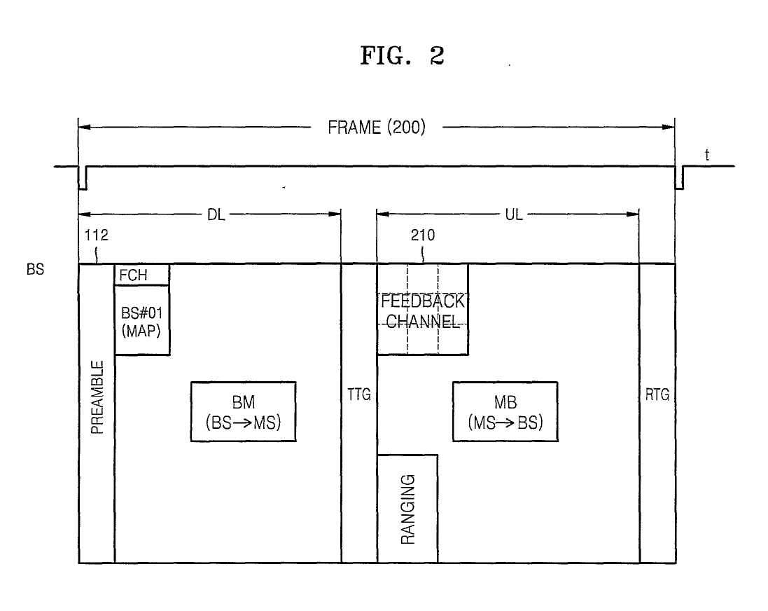

FIG. 2 is a diagram illustrating an example of a structure of a frame 200 of a Worldwide Interoperability for Microwave Access (WiMAX) Time Division Duplexing (TDD) system.

Referring to FIG. 2, the frame 200 is configured with a downlink (DL) zone (BM:BS→MS) in which data is transmitted from a Base Station (BS) to a Mobile Station (MS) and a uplink (UL) zone (MB:MS→BS) in which data is transmitted from the MS to the BS.

In a WiMAX system, the BS has to monitor a channel status of MSs so as to efficiently manage the MSs. For this purpose, the BS allocates a feedback zone 210 to the UL zone (MB:MS→BS) of the frame 200 and requires the MSs to report channel quality information via a channel of the feedback zone 210. The BS efficiently manages the MSs by using the reported channel quality information.

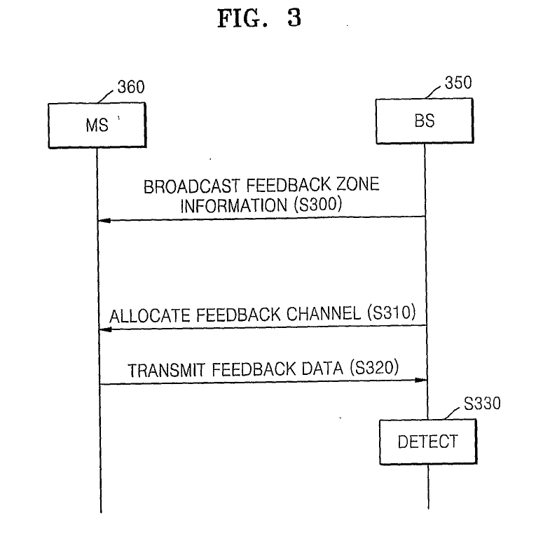

FIG. 3 is a flowchart of a method of transmitting feedback data in the WiMAX TDD system according to an embodiment of the present invention.

Referring FIGS. 2 and 3, a BS 350 broadcasts allocation information (e.g., [x,y]) informing a location and a size of the feedback zone 210 which is allocated to the UL zone (MB:MS→BS) (operation S300). An MS 360 analyzes information on the feedback zone 210 from the broadcasted information. The BS 350 transmits a channel quality requirement message including a feedback channel number to the MS 360 that is activated (operation S310). The MS 360 periodically transmits channel quality information to the BS 350 via a channel which corresponds to the feedback channel number included in the channel quality requirement message and which is from among channels of the feedback zone 210 (operation S320).

The BS 350 identifies the MS 360, which has transmitted the channel quality information, by using a location of the feedback channel which has received the channel quality information (operation S330) and uses the received channel quality information. Feedback information requires a rapid response, and thus, is transmitted in the form of modulated data, not in the form of a message, to the BS 350. The BS 350 only performs demodulation and thereby rapidly recognizes the data transmitted via the feedback channel.

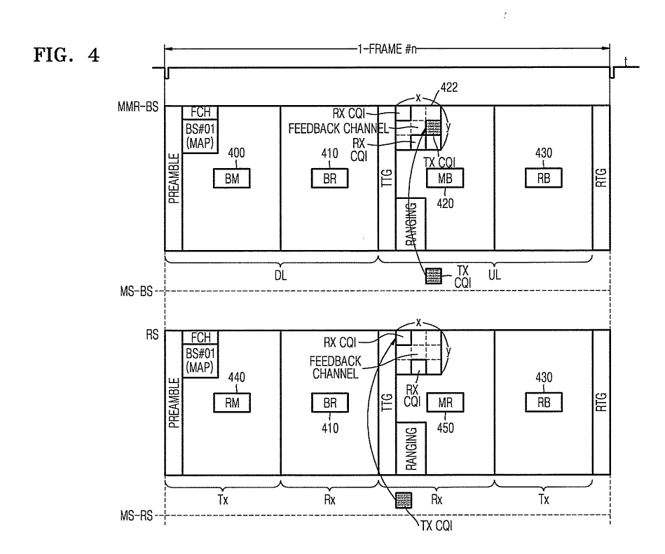

FIG. 4 is a diagram illustrating an example of a framestructure in a Mobile Multi-hop Relay (MMR) system.

Referring to FIG. 4, from a BS point of view, the frame is configured with a DL zone which includes a zone (hereinafter, a BM zone) 400 in which data is transmitted from the BS to an MS and a zone (hereinafter, a BR zone) 410 in which data is transmitted from the BS to a RS, and a UL zone which includes a zone (hereinafter, a MB zone) 420 in which data is transmitted from the MS to the BS and a zone (hereinafter, a RB zone) 430 in which data is transmitted from the RS to the BS. A feedback zone 422 is respectively allocated to the MB zone 420 and the MR zone 450. Time-division and frequency-division are available in the respective zones of the frame, and an order of the zones is changeable.

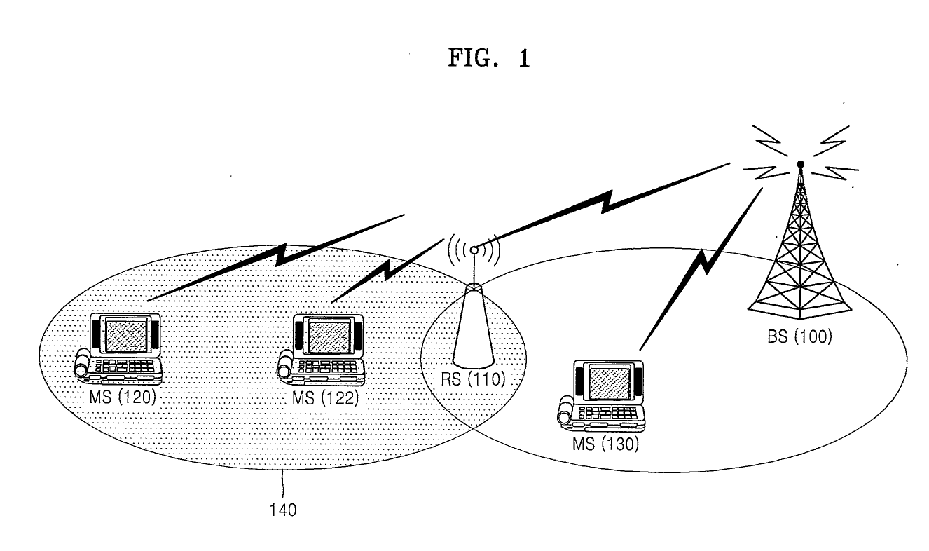

Likewise to the method described in relation to FIG. 3, an MS (such as an MS 130 of FIG. 1), which is activated in a zone of a BS, is allocated a feedback channel via a channel quality requirement message of the BS and transmits feedback data via the feedback channel. However, in the MMR system, an MS (such as MSs 120 or 122 in FIG. 1), which is activated in a zone of a RS, transmits the feedback data via the feedback channel allocated by the BS but a primary receiver of the feedback data is the RS. The RS has to re-transmit the received feedback data to the BS.

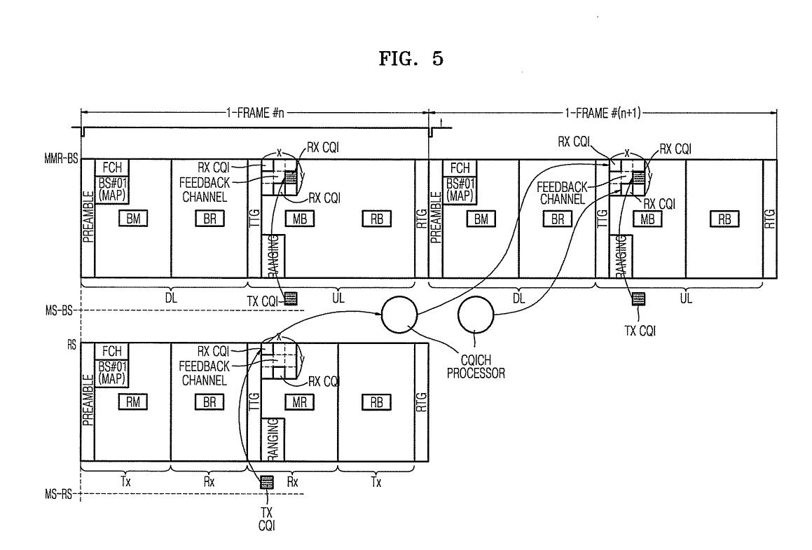

FIG. 5 is a diagram illustrating an example of a method of transmitting the feedback data by the RS in the MMR system.

Referring to FIG. 5, in order to transmit the feedback data received from the MS to the BS via the feedback channel allocated to the MS, the RS has to use a UL zone of a next frame, whereby a considerable time delay occurs.

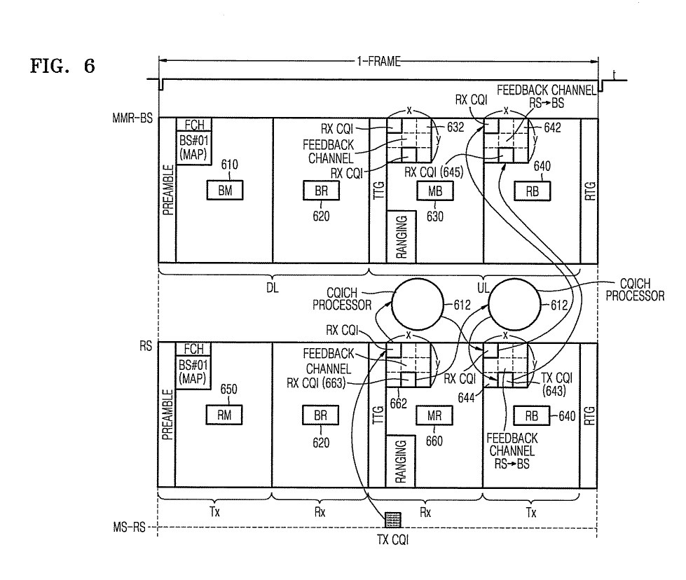

FIG. 6 is a diagram illustrating a framestructure in an MMR system, according to an embodiment of the present invention.

Referring to FIG. 6, from a BS point of view, a frame according to the present invention is configured with a DL zone which includes a zone (hereinafter, a BM zone) 610 in which data is transmitted from the BS to an MS and a zone (hereinafter, a BR zone) 620 in which data is transmitted from the BS to a RS, and a UL zone which includes a zone (hereinafter, a MB zone) 630 in which data is transmitted from the MS to the BS and a zone (hereinafter, a RB zone) 640 in which data is transmitted from the RS to the BS. From a RS point of view, the BM zone 610 corresponds to a RM zone 650 in which data is transmitted from the RS to the MS, the MB zone 630 corresponds to an MR zone 660 in which data is transmitted from the MS to the RS. Feedback zones 632, 662, and 644 which have the same location and size are allocated to each of the MB zone 630, the MR zone 660, and the RB zone 640. Here, a zone (such as the MB zone 630 or the MR zone 660) in which the data is transmitted from the MS to the BS or the RS is called as an ‘access zone’, and a zone (such as the RB zone 640) in which the data is transmitted from the RS to the BS is called as a ‘relay zone’.

For example, when the BS attempts to be reported a Channel Quality Indicator (CQI) of down link by the MS, the BS may allocate a Channel Quality Information Channel (CQICH) to the MSs. The CQICH may be allocated to the access zone of an access link and may be selectively allocated to the relay zone. Thus, the RS may transmit the CQI, which is received from the MS via the access zone, to the BS via a corresponding CQICH of the relay zone. A feedback zone for reporting CQI values of the MS in the relay zone to the BS may be allocated by transmitting feedback zone allocation information (e.g., FAST-FEEDBACK allocation IE of Institute of Electrical and Electronics Engineers (IEEE) 802.16j) to the RS by using a unicast method. A feedback slot allocation in the relay zone has to be the same as a feedback slot allocation in the access zone of the RS.

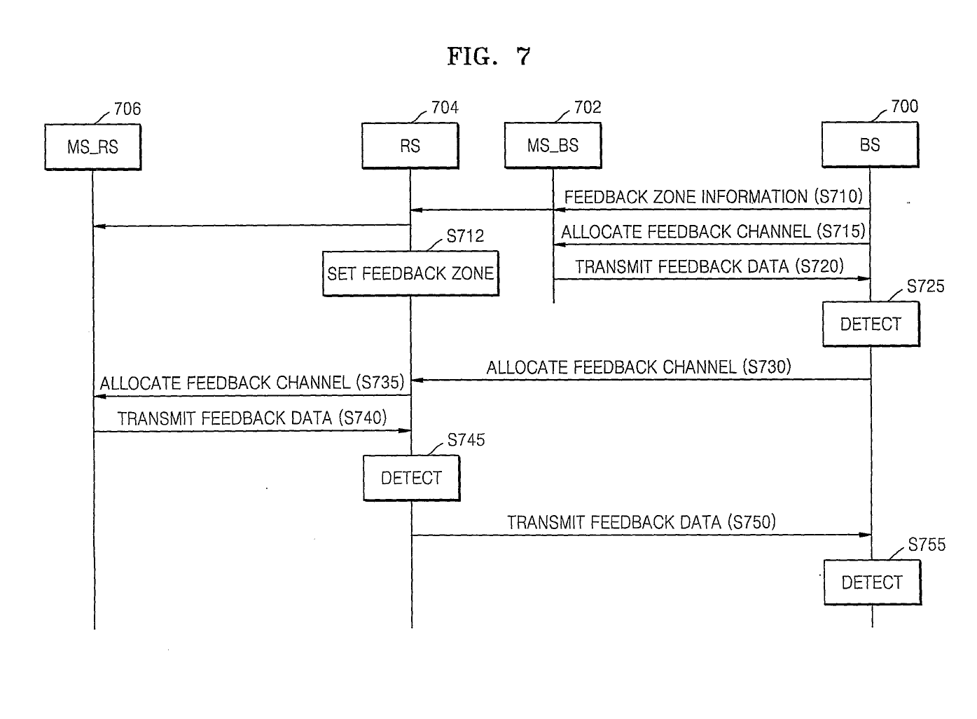

FIG. 7 is a flowchart illustrating a method of configuring a feedback zone of the framestructure illustrated in FIG. 6 in the MMR system according to another embodiment of the present invention.

Referring FIGS. 6 and 7, a BS 700 broadcasts feedback allocation information informing a location and a size of the feedback zone allocated to the MB zone 630 (operation S710). In order to set a feedback channel with an MS 706, a RS 704 sets a feedback zone in the MR zone 660 based on the feedback allocation information, wherein the feedback zone is the same as the feedback zone allocated to the MB zone 630 (operation S712). Also, in order to transmit feedback data received from the MS 706 to the BS 700, the RS 704 sets a feedback zone in the RB zone 640, wherein the feedback zone is the same as the feedback zone of the MR zone 660 (operation S712).

Likewise to the method described in relation to FIG. 3, an MS 702 (that corresponds to the MS 130 of FIG. 1), which is activated in a zone of the BS 700, is allocated a feedback channel via a channel quality requirement message of the BS 700 (operation S715). The MS 702 transmits feedback data to the BS 700 via the feedback channel (operation S720). The BS 700 identifies the MS 702 by using a receiving channel of the feedback data and uses the received feedback data (operation S725).

However, in the MMR system, in the case of the MS 706 (that corresponds to the MS 120 of FIG. 1) which is activated in a zone of the RS 704, the BS 700 transmits the channel quality requirement message including a channel number to the MS 706 via the RS 704.

The MS 706 transmits feedback data to the RS 704 via a channel which is of the feedback zone 662 in the MR zone 660 and which corresponds to the channel number allocated by the BS 700 (operation S740). The RS 704 identifies the MS 706 by using a location 663 of the channel which has received the feedback data (operation S745). The RS 704 demodulates the received feedback data after performing a simple processing procedure and transmits the demodulated feedback data to the BS 700 via a corresponding channel 643 of the feedback zone 644 of the RB zone 640 (operation S750). The BS 700 checks a channel 645 which receives the feedback data in a feedback zone 642 of the RB zone 640 and thereby identifying the MS 706 (operation S755). Since a location which receives and transmits the feedback data is identical in each of the feedback zones, a separate prior processing procedure or a post processing procedure is not necessary and the feedback data is transmitted from the MS 706 to the BS 700 within one frame without a delay of a frame.

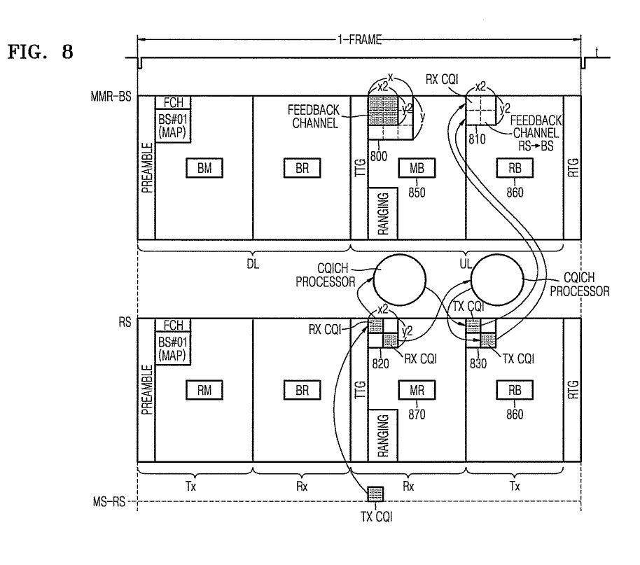

FIG. 8 is a diagram illustrating a framestructure in an MMR system, according to another embodiment of the present invention.

Referring to FIG. 8, the framestructure according to the current embodiment has different feedback zones 810, 820, and 830 which are set in an MR zone 870 and a RB zone 860, compared to the framestructure illustrated in FIG. 6. However, the rest of zones are the same.

The current embodiment is to provide the framestructure for reducing allocation quantity of a feedback channel of the RB zone 860. That is, the framestructure illustrated in FIG. 6 allocates the feedback zone 642 to the RB zone 640, wherein the feedback zone 642 has a location and a size which are the same as the feedback zone 632 of the MB zone 630. However, the framestructre of FIG. 8 includes the feedback zone 810 in the RB zone 860, wherein the feedback zone 810 has a same location and a different size, compared to a feedback zone 800 of an MB zone 850. Thus, a BS transfers size information (x2, y2) on the feedback zone 810 of the RB zone 860 to a RS, and the RS sets the feedback zones 820 and 830, which have a specific size (x2, y2) received from the BS, in the MR zone 870 and the RB zone 860.

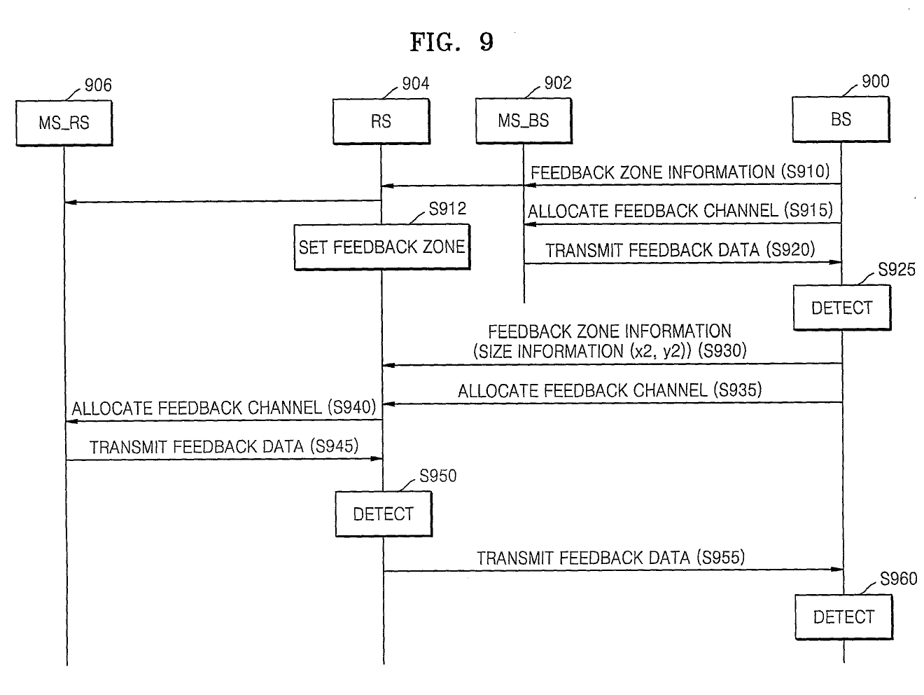

FIG. 9 is a flowchart illustrating a method of configuring a feedback zone of the framestructure illustrated in FIG. 8 in the MMR system according to another embodiment of the present invention.

Referring FIGS. 8 and 9, the framestructure of FIG. 8 allocates the feedback zone 810 to the RB zone 860, wherein the feedback zone 810 has the same location and the different size compared to the feedback zone 800 of the MB zone 850. Thus, the method in relation to FIG. 9 further includes operation S930 in which a BS 900 transmits the size information (x2, y2) of the feedback zone 810 to be allocated to the RB zone 860. Each of operations other than operation S930 is identical with each of the operations described in relation to FIG. 7, and thus, a detailed description thereof is omitted here.

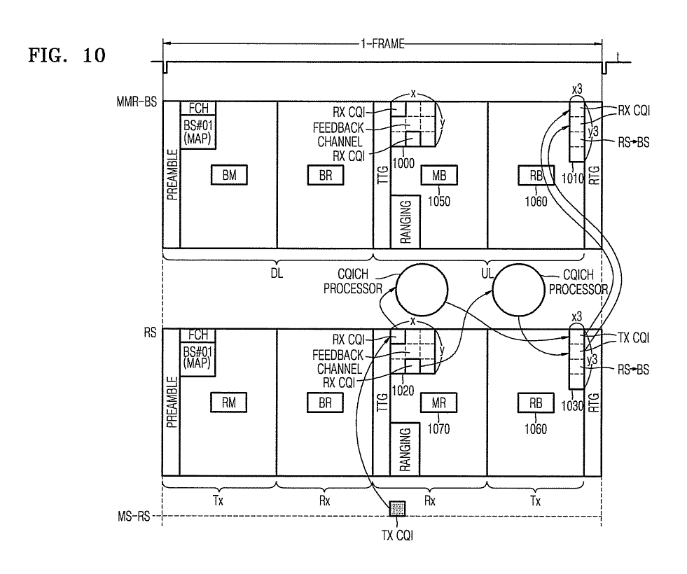

FIG. 10 is a diagram illustrating a framestructure in an MMR system, according to another embodiment of the present invention.

Referring to FIG. 10, the framestructure according to the current embodiment has different feedback zones 1010 and 1030 which are set in a RB zone 1060, compared to the framestructure illustrated in FIG. 6. However, the rest of zones are the same.

In order to reduce allocation quantity of a feedback channel of the RB zone 1060, a BS sets the feedback zone 1030 of the RB zone 1060 to a specific location and a specific size (x3, y3). In the case of FIG. 8, the feedback zone 800 of the MB zone 850 has the same location and the different size compared to the feedback zone 810 of the RB zone 860. However, in the case of FIG. 10, a feedback zone 1000 of an MB zone 1050 has a location and a size which are different from those of the feedback zone 1010 of the RB zone 1060. Thus, the BS transfers size information (x3, y3) on the feedback zone 1010 of the RB zone 1060 and location information on each channel to a RS, and the RS sets the feedback zones 1020 and 1030 in the MR zone 1070 and the RB zone 1060, wherein the feedback zone 1030 has a location and a size (x3, y3) received from the BS. Also, the BS transmits a transformation table to the RS, wherein the transformation table relates to a transformation between the feedback channel 1000 of the MB zone 1050 and the feedback channel 1010 of the RB zone 1060.

For example, the BS sets channel transformation information including a content regarding “a feedback channel #7 of the MB zone 1050 is transformed to a feedback channel #1 of the RB zone 1060 and used.” and transfers the channel conversion information to the RS. The RS receives feedback data from the MS via the feedback channel #7 of the MR zone 1070 and transmits the feedback data to the BS via the feedback channel #1 of the RB zone 1060 by using a transformation table.

The BS monitors the feedback zone 1010 of the RB zone 1060, and when the feedback data is received via the feedback channel #1 of the RB zone 1060, the BS inversely adopts the transformation table and recognizes that the feedback data has been received via the feedback channel #7 of the MB zone 1050, thereby identifying the MB to which the feedback channel #7 is allocated.

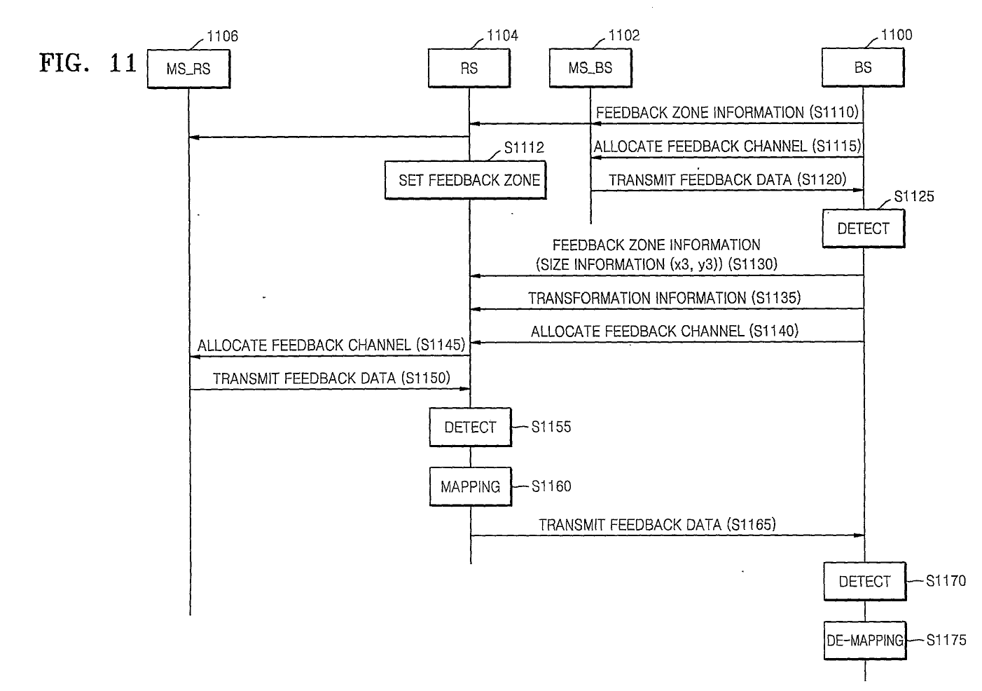

FIG. 11 is a flowchart illustrating a method of configuring a feedback zone of the framestructure illustrated in FIG. 10 in the MMR system according to another embodiment of the present invention.

Referring FIGS. 10 and 11, the framestructure of FIG. 10 allocates the feedback zone 1010 to the RB zone 1060, wherein the feedback zone 1010 has a location and a size which are different from those of the feedback zone 1000 of the MB zone 1050. Thus, the method in relation to FIG. 11 further includes operation S1130 in which a BS 1100 transmits the size information (x3, y3) of the feedback zone 1010 to be allocated to the RB zone 1060 and channel location information and operation S1135 in which the BS 1100 transmits information informing a transformation relationship between the feedback zone 1000 of the MB zone 1050 and the feedback zone 1010 of the RB zone 1060. Each of operations other than operations S1130 and S1135 is identical with each of the operations described in relation to FIG. 7, and thus, a detailed description thereof is omitted here.

A RS 1104 allocates a feedback channel to the RB zone 1060 and transmits the feedback data to the BS 1100, wherein the feedback data is received from an MB 1106 via the feedback channel.

As described above, the method according to the present invention can transmit feedback data of an MS to a BS in one frame without a separate delay of a frame, wherein the MS is in a range of a RS, and thus, the method can configure a system which has a function of a feedback channel requiring a rapid response in the MMR system. The method can also be applied to an ACK/NACK channel configuration method for transmitting an ACK/NACK signal.

The invention can also be embodied as computer readable codes on a computer readable recording medium. The computer readable recording medium is any data storage device that can store programs or data which can be thereafter read by a computer system. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. A method of configuring a feedback zone in a BS (base station) in a wireless communication system, the method comprising:
allocating a first feedback zone in an access zone in which data is transmitted from an MS (mobile station) to the BS; and
allocating a second feedback zone in a relay zone in which data is transmitted from a RS (relay station) to the BS, wherein the second feedback zone corresponds to the first feedback zone.

2. The method of claim 1, wherein locations of feedback channels comprising each of the first feedback zone and the second feedback zone are identical with each other.

3. The method of claim 1, wherein size of the first feedback zone and the second feedback zone are identical with each other.

4. The method of claim 1, further comprising transmitting allocation information of the first feedback zone.

5. The method of claim 4, wherein the transmitting comprises transmitting the allocation information by using a unicast method.

6. The method of claim 1, further comprising:
allocating a feedback channel of the first feedback zone to the MS; and
receiving feedback data via a channel of the second feedback zone, wherein the channel corresponds to the feedback channel.

7. The method of claim 6, wherein the feedback channel is a CQICH (Channel Quality Information Channel) and the feedback data is channel quality information of the MS.

8. A method of configuring a feedback zone in a RS in a wireless communication system, the method comprising:
receiving allocation information, of a first feedback zone allocated to an access zone in which data is transmitted from an MS to a BS, from the BS; and
allocating a second feedback zone to an relay zone in which data is transmitted from the RS to the BS based on the allocation information of the first feedback zone, wherein the second feedback zone corresponds to the first feedback zone.

9. The method of claim 8, further comprising allocating a third feedback zone to a zone in which data is transmitted from the MS to the RS based on the allocation information of the first feedback zone, wherein the third feedback zone is the same as the first feedback zone.

10. The method of claim 8, wherein a location of feedback channels comprised in each of the first feedback zone and the second feedback zone is identical with each other.

11. The method of claim 8, wherein a size of the first feedback zone and the second feedback zone is identical with each other.

12. The method of claim 8, further comprising transmitting feedback data received from the MS to the BS via the second feedback zone.

13. A computer readable recording medium having recorded thereon a framestructure of a wireless communication system, the framestructure comprising:
a first feedback zone allocated to an access zone in which data is transmitted from an MS to a RS or a BS; and
a second feedback zone allocated to a zone in which data is transmitted from the RS to the BS, wherein the second feedback zone corresponds to the first feedback zone.

14. The computer readable recording medium of claim 13, wherein a location of feedback channels comprised in each of the first feedback zone and the second feedback zone is identical with each other.

15. The computer readable recording medium of claim 13, wherein a size of the first feedback zone and the second feedback zone is identical with each other.
